(19) United States
(12) Patent Application Publication
(10) Pub. No.: US 2010/0214267 A1
(43) Pub. Date: Aug. 26, 2010

(54) MOBILE DEVICE WITH VIRTUAL KEYPAD

(75) Inventors: Zoran Radivojevic, Helsinki (FI); Zou Yanming, Beijing (CN); Wang Kongqiao, Beijing (CN); Matti Hamalainen, Lempaala (FI); Jari A. Kangas, Tampere (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/295,751

(22) PCT Filed: Jun. 15, 2006
(86) PCT No.: PCT/EP06/05728

§ 371 Date: May 7, 2010

(51) Int. Cl. G06F 3/042; G06F 3/043; G06F 3/048

(52) U.S. Cl. 345/175; 715/771; 345/177

(57) ABSTRACT

A mobile electronic device with a virtual input device. The virtual input device includes an optical sensor for detecting movement of a user's fingers over a work surface and an acoustic or vibration sensor, for detecting an impact of the user's fingers on the work surface. A processor, coupled to the optical sensor and to the acoustic sensor, processes the detected signals as input for the electronic device. The user's fingers can be shown on the display overlaid by a virtual mask. The virtual mask may show a keyboard of menu items.

### FIELD OF THE INVENTION

The present invention relates to input devices for mobile electronic devices, in particular to virtual input devices for mobile electronic devices.

### BACKGROUND OF THE INVENTION

US 2004046744 discloses an input device for a mobile electronic device such as a PDA, a mobile phone, an appliance using a virtual input device such as an image of a keyboard. The input device includes an optical projector that is used to project an image of a keyboard on a work surface. A dedicated optical sensor captures positional information as to the location of the user's fingers in relation to the projected keyboard. This information is processed with respect to finger locations and velocities and shape to determine when virtual keys would have been struck. The input device is formed as a companion system that is attached to the mobile. This known system has the advantage of providing a small and light portable system that includes a full-size QWERTY type keyboard (or similar for other languages or other character sets such as Cyrillic, Arabic, or various Asian character sets), thereby overcoming one of the major drawbacks of small mobile devices which otherwise have to deal with small keypads or other input means that tend to be less effective than full-size QWERTY type keyboards. However, the companion system requires a substantial amount of additional hardware, thereby increasing the cost and complexity of the mobile device. Further, add-on systems tend to have a lower reliability than integrated systems. Further, the accuracy of systems based on an optical sensor for determining the position of the users fingers needs improvement. Another disadvantage associated with virtual projection keyboards is the lack of tactile feedback, and this aspect also requires improvement.

### DISCLOSURE OF THE INVENTION

On this background, it is an object of the present invention to provide a mobile electronic device with an improved virtual input device. This object is achieved by providing a mobile electronic device with a virtual input device, said mobile electronic device comprising an optical sensor, for detecting movement of a user's fingers over a work surface, and for generating a signal responsive to the detected movement, an acoustic or vibration sensor, for detecting an impact of the user's fingers on the work surface and for generating a signal responsive to the detected impact, a first processor, coupled to the optical sensor and a second processor coupled to the acoustic sensor, for receiving and processing the detected signals as input for the electronic device.

By using the vibration or sound caused by the fingertips of the user impacting with a work surface a distinct and clear moment of completion of the user input is established. This clearly defined moment of input will improve feedback to the user and the combined signals of the optical and the acoustic/vibration sensor improve accuracy in recognizing whether or not an input has been made. Further, since the user needs to knock on the work surface he/she is provided with tactile feedback.

If no suitable work surface is available, the sound triggering the input can be imitated by the user using his/her voice. The device can be calibrated to adapt to voice triggered input.

Preferably, the first processor is configured to determine the position where a finger impacts with the work surface from the signal generated by the optical sensor and to determine that an impact of a finger and the work surface has taken place from the signal generated by the acoustic or vibration sensor.

A particular input command may be associated with each of a plurality of fingertip positions, and the first processor can be configured to accept the function associated with a given fingertip position when a fingertip movement towards the position concerned is detected to substantially coincide with the detection of a fingertip impact.

The processor may also be configured to track the movement of the user's fingers.

The device may further comprise a display, wherein the first processor is configured to provide real-time fingertip positions projected at the display. Thus, it is possible to provide the user with optical feedback. Preferably, the second processor is configured to detect an impact of a finger with the work surface by performing a triggering algorithm in which the signal from the acoustic sensor is processed to perform a logical switch operation. The triggering algorithm can be based on the sounds or vibration that travel through the solids in the environment of the acoustic or vibration sensor, the sounds that travel through the air in the environment of the acoustic sensor, or on a combination of the sounds or vibrations that travel to the solids in the environment of the acoustic or vibration sensor and the sounds that travel through the air in the environment of the acoustic sensor.

The triggering algorithm may use coincidences between audio signals from a finger impacting with the work surface or optionally from the user's voice, and finger movements, which have to be above a certain threshold. Thus, only when both conditions are fulfilled, a user input is accepted.

Further, the first processor can be configured to show a virtual navigation mask on the display for providing optical feedback/guidance to the user. The virtual navigation mask may include virtual input elements comprising virtual keypads or keyboards, virtual touch pads, icons and/or menu items.

The first processor may further be configured to highlight the virtual input element associated with the fingertip position when a fingertip movement towards said fingertip position and a fingertip impact have been detected. Thereby, optical feedback to the user can be further improved

The device housing may comprise a front side in which the display is disposed and a rear side in which the optical sensor is disposed, said device further comprising a support member for keeping the housing in a substantially upright position. The support member also assists in propagating the sound and/or vibrations through the solid material to the sensor(s) in the device.

Preferably, the optical sensor is a general-purpose digital photo or video camera. Thus, an optical sensor that is already present in many mobile devices can be used for a second purpose. The acoustic sensor can be a general-purpose microphone. Thus, an acoustic sensor that is already present in many mobile devices can be used for a second purpose.

It is another object on the present invention to provide an improved method for generating input in a mobile electronic device. This object is achieved by providing a method for generating input in a mobile electronic device comprising optically detecting a movement of a user's fingers over a work surface, acoustically or vibrationally detecting impact of a user' fingers on the work surface, and processing said signals as input.

Preferably, the method further comprises determining the position where a finger impacts with the work surface from the signal generated by the optical sensor and determining that an impact of a finger and the work surface has taken place from the signal generated by the acoustic or vibration sensor.

The method may also comprise the steps of associating a particular input command with each of a plurality of fingertip positions, and accepting the input command associated with a given fingertip position when a fingertip movement towards the position concerned is detected substantially simultaneously with the detection of a fingertip impact.

The method may further comprise the steps of processing the signals from the optical sensor and from the acoustic or vibration sensor to determine whether a fingertip of said user contacted a location defined on said virtual input device, and if contacted to determine what function of said virtual input device is associated with said location.

Preferably, the method also comprises the step of tracking the movement of the user's fingers and finger speed.

The device may comprise a display, and the method may comprise providing real-time fingertip positions projected at the display.

Preferably, the method comprises detecting an impact of a finger with the work surface by performing a triggering algorithm in which the signal from the acoustic sensor is processed to perform a logical switch operation.

The method may also comprise the step of showing a virtual navigation mask on the display for providing optical feedback to the user.

The method may further comprise the step of highlighting the virtual input element associated with the fingertip position when a fingertip movement towards said fingertip position and a fingertip impact have been detected.

It is another object of the invention to provide a mobile device with a virtual input device that does not need to rely on a companion system. This object is achieved by providing a mobile electronic device with a virtual input device, said mobile electronic device comprising an optical sensor, for detecting movement of a user's fingers over a work surface, and for generating a signal responsive to the detected movement, a processor coupled to said optical sensor for receiving and processing the detected signal as input for the electronic device, and a display coupled to the optical sensor, wherein the processor is configured to show a real-time representation of the position user's fingers or fingertips as captured by the optical sensor on the display.

Many mobile devices already include an optical sensor in the form of a digital camera and already have a display. Therefore, the virtual input device can be realized without adding new hardware. Thereby, the device can be kept compact and light. Further, since the virtual input device is realized through software, it is very easy to adapt the virtual input device to various needs and circumstances.

The processor may be configured to provide real-time fingertip positions projected at the display.

The representation of the user's fingers on the display can be in the form of pointers or hand- or finger shadows. Alternatively, the representation of the user's fingers on the display can be in the form real time images.

The representation of the user's fingers on the display may be projected into another application.

Preferably, the processor is configured to display a virtual navigation mask over the representation of the users fingers for providing optical feedback to the user.

The virtual navigation mask may include virtual input elements. The virtual input elements can be virtual keypads or keyboards, icons and/or menu items.

Preferably, processor is configured to determine the position where a finger impacts with the work surface from the signal generated by the optical sensor.

A particular input command can be associated with each of a plurality of fingertip positions, and said processor can be configured to accept the function associated with a given fingertip position when a fingertip movement towards the position concerned is detected.

The processor can be configured to track the movement of the user's fingers or fingertips.

The optical sensor can be a general-purpose digital photo or video camera.

An object above is also achieved by providing a method for generating input in a mobile electronic device with an optical sensor and a display comprising optically detecting movement of a user's fingers over a work surface, showing a real-time representation of the position user's fingers or fingertips as captured by the optical sensor on the display, and processing said signals as input.

The method may further comprise tracking the movement of the user's fingers and/or fingers speed.

Preferably, the method further comprises determining the position where a finger impacts with the work surface from the signal generated by the optical sensor.

A particular input command may be associated with each of a plurality of fingertip positions.

The method may also comprise showing a virtual navigation mask on the display for providing optical feedback to the user. The virtual navigation mask may include virtual input elements comprising virtual keypads or keyboards, icons and/or menu items.

Preferably, the method further comprises highlighting the virtual input element associated with the fingertip position when a fingertip movement towards said fingertip position and a fingertip impact have been detected.

The virtual mask may only show the characters or symbols associated with the key of a virtual keypad. Alternatively, the virtual mask further shows key contours of the keys of a virtual keypad or shows partition lines between the characters or symbols associated with the key of a virtual keypad.

Further objects, features, advantages and properties of the device and method according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile electronic device according to an embodiment of the invention,

FIG. 2 is a rear view of the device shown in FIG. 1,

FIG. 3 is an elevated view of the device shown in FIG. 1 whilst in use in a cradle on a work surface,

FIG. 4 is a side view of the device shown in FIG. 1 whilst placed in a cradle on a work surface,

FIG. 4A is a side view of a mobile electronic device according to a further embodiment of the invention on a work surface,

FIG. 4B is a front view of the device of FIG. 4A, and

FIG. 5 is a block diagram illustrating the general architecture of a device shown in FIG. 1.

### DETAILED DESCRIPTION OF PREFERRED EMBODIMENTS

In the following detailed description, the mobile electronic device and the method according to the invention in the form of a cellular/mobile phone will be described by the preferred embodiments.

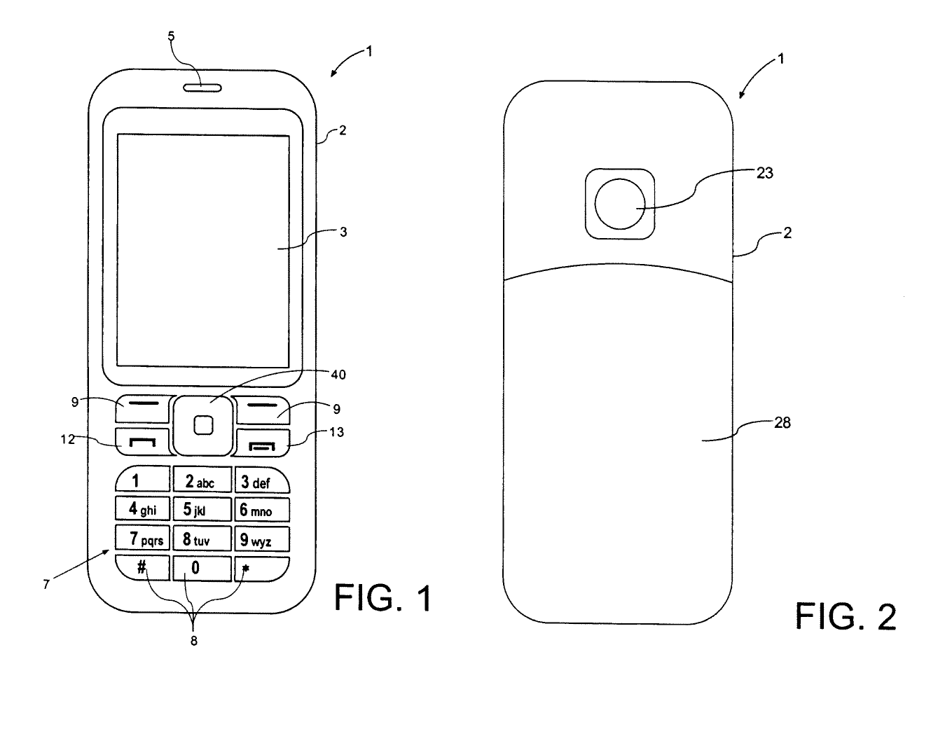

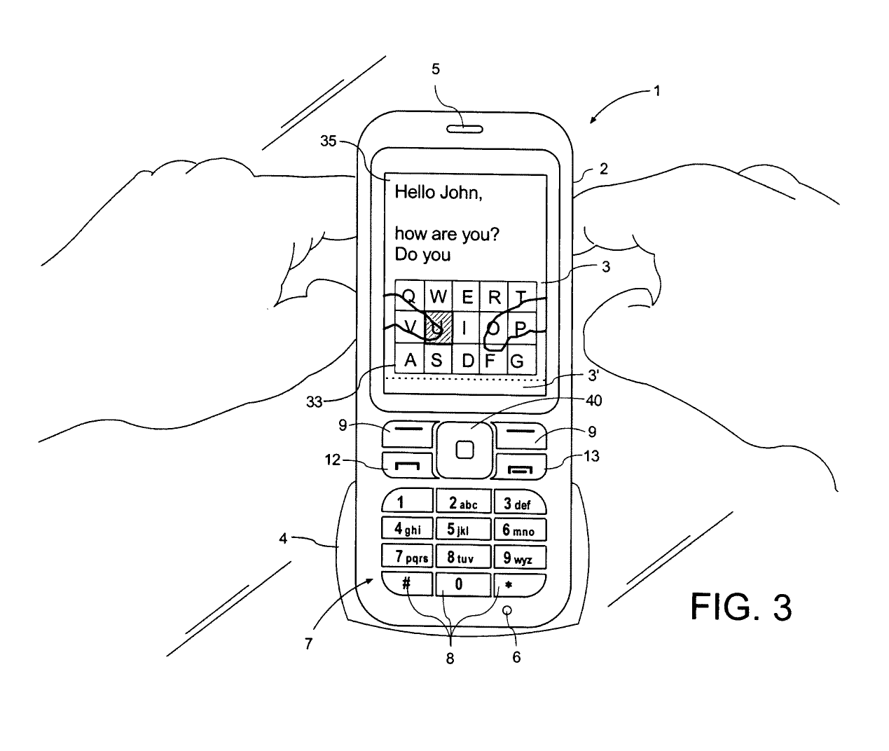

FIGS. 1 and 2 illustrate a first embodiment of a mobile terminal according to the invention in the form of a mobile telephone 1 by a front view and a rear view, respectively. The mobile phone 1 comprises a user interface having a housing 2, a display 3, an on/off button (not shown), a speaker 5 (only the opening is shown), and a microphone 6 (only the opening in the housing 2 leading to the microphone is shown. The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 with alphanumeric keys. The keypad 7 has additionally a second group of keys comprising two softkeys 9, two call handling keys (offhook key 12 and onhook key 13), a five way navigation key 40 for scrolling and selecting. The function of the softkeys 9 depends on the state of the mobile phone 1, and navigation in the menu is performed by using the navigation key 40. The present function of the softkeys 9 is shown in separate fields (soft labels) in a dedicated area 3′ of the display 3, just above the softkeys 9. The two call handling keys 12,13 are used for establishing a call or a conference call, terminating a call or rejecting an incoming call.

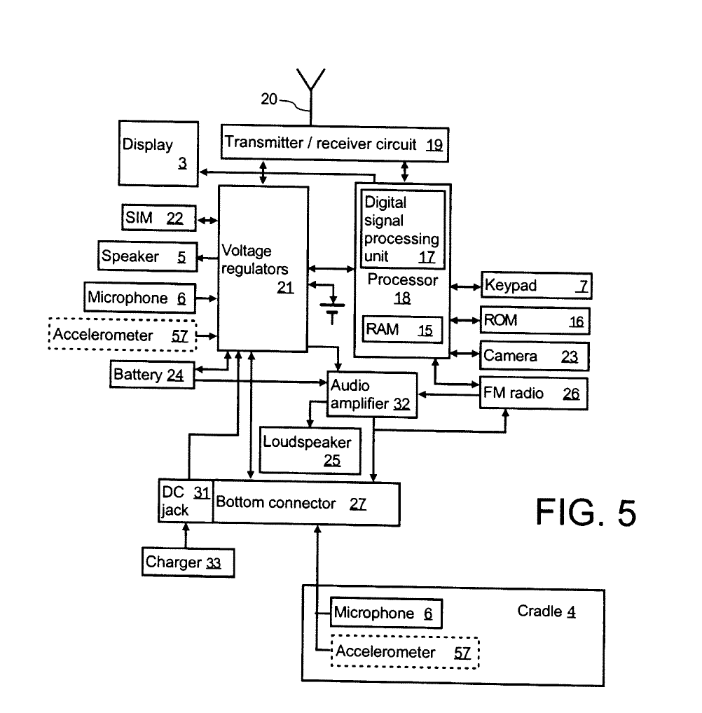

A releasable rear cover 28 gives access to the SIM card 22 (FIG. 5), and the battery pack 24 (FIG. 5) in the back of the mobile phone 1 that supplies electrical power for the electronic components of the mobile phone 1.

The mobile phone 1 has a flat display 3 that is typically made of an LCD with optional back lighting, such as a TFT matrix capable of displaying color images. A touch screen may be used instead of a conventional LCD display.

A digital camera 23 (only the lens is visible in FIG. 2) is placed in the rear side of the mobile phone 1.

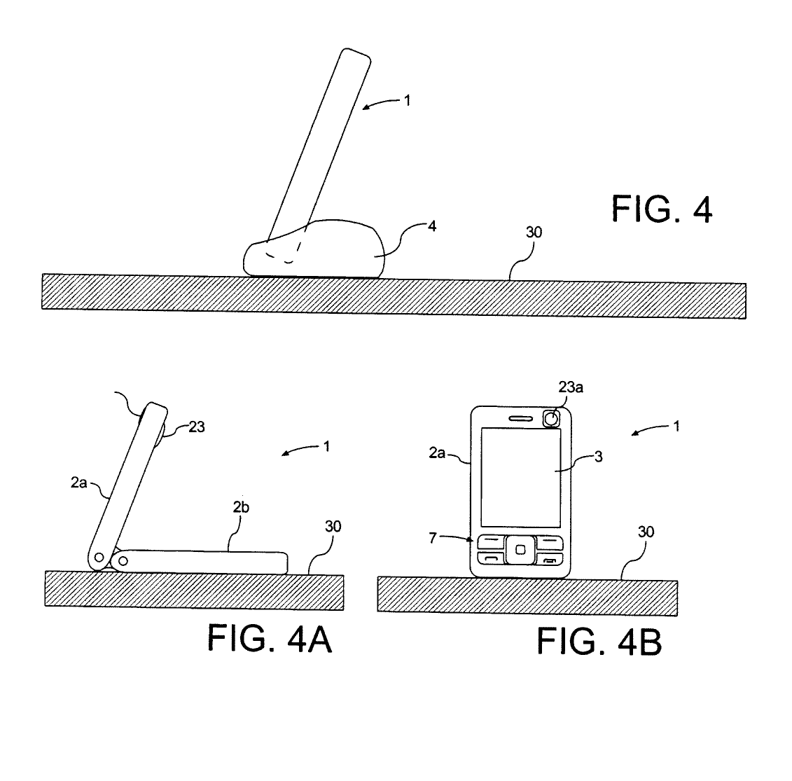

FIGS. 3 and 4 show the mobile phone 1 placed in a cradle on a work surface 30. The cradle 4 may include a microphone 6 and/or an accelerometer 57 that are coupled to the mobile phone 1 via the bottom connector 27 (FIG. 5). FIG. 3 also shows the position of the hands of a user when the mobile phone 1 is used with the virtual input means that are herebelow described in greater detail.

The hands of the user are placed over the work surface 30, here atop a desk, in the viewing area of the digital camera 23. The work surface 30 is used as a virtual keyboard, keypad, touchpad or other virtual input means provided with positions that have functions associated thereto. The work surface 30 also serves to provide the user with tactile feedback, which is received from the impact of a finger tip with the work surface. The user is supposed to move his/her fingertips towards the positions on the work surface that have input functions associated therewith. The camera 23 is used to track the movement of the fingers of the user and to provide real-time fingertip positions projected on the display 3.

When using the virtual input device, the user is expected to “tap” with his or her finger tips on the work surface at the above-mentioned positions thereby creating an impact between the fingertip and the work surface 30. The microphone 6 or an accelerometer 57 (FIG. 5) are used to register the impact between the user's fingertip and the work surface 30 to accept a command or function attributed to the position at which the fingertip makes contact with the work surface. The optimal position for the microphone 6 and the accelerometer 57 are is at the bottom of the chassis of the mobile phone 1. The microphone 6 can be used to register the sound of the impact as it travels through the solid materials between the position of impact and the microphone 6 and/or to register the sound as it travels through the air between the position of impact and the microphone 6. The accelerometer 57 can be used to register the vibrations traveling through the solid materials between the position of impact and the accelerometer 57.

A virtual navigation mask or pattern 33 is optionally shown on the display 3. The exemplary mask 33 illustrated in FIG. 3 is a partial QWERTY keyboard. In larger portable devices or devices having a display with a landscape orientation (not shown) it is possible to display a mask with a full QWERTY keyboard. The mask 33 to be displayed is therefore only dependent upon the size and shape of the display 3. The mask 33 is not limited to the QWERTY keyboard layout, other langue layout and other character sets, such as for example Cyrillic, Arabic, Hebrew or various Asian character sets can equally be used.

The navigation mask 33 gives the user visual feedback since the user can see his/her fingers with the virtual keyboard overlaying them. The user can thereby follow his/her finger movements directly on the display 3 where the mask 33 is drawn in a shadow mode. The mask provides optical navigation to the user so that he/she can correlate the finger movements while interacting with the mobile phone 1. In the example illustrated in FIG. 3 a text that has been entered with the virtual keyboard is shown directly above the mask 33 in a text window 35, thereby allowing the user to see the entered text and the keyboard simultaneously, which is of advantage for users who are not very good at blind typing.

The signal from the camera 23 is used to determine which of the positions having a function associated therewith have been touched by a user's fingers whilst the signal from the microphone 6 and/or the accelerometer 57 is used to trigger/accept the function or command associated with the position that has been touched. Thus, there is a clear point in time for the completion of an input by the user. At this point of time the user is optionally provided with an optical feedback that is created by highlighting the key of the virtual keypad in the display 3. Thus, when fingers are moved towards positions having input functions associated herewith, and the support surface 30 is impacted, the microphone 6 and/or the accelerometer 57 sends a confirmation that the function associated with the position on the virtual input device is to be executed. An advanced user may not need the mask permanently shown, thereby freeing up space on the display 3. Thus, an advanced user can switch the mask off, while interacting activation confirmation could be shown with letter indication and finger locations, using a transparent “ghost” image.

According to a variation of this embodiment (not shown) the mobile device 1 is provided with a rotatable camera housing or with a forward facing camera (directed towards the user) so that the user's hands are placed to the front of the device instead of being positioned behind the rear face of the product as illustrated in FIG. 3. The mobile device according to this variation of the embodiment or according to the embodiment itself may be coupled to an external displaying device, such as a projector for displaying the users hands (or pointers or shadows representing the users fingers or hands) eventually overlaid by the virtual mask. In this use scenario the mobile device serves as hand (fingertip) scanner and the pointers (or hand shadows) are projected into an application displayed on a wall or screen by the external device projector.

In a variation (not shown) of the present embodiment the mobile phone 1 is provided with a folding leg or other support member that is integral with the phone allowing it to stand upright on a work surface without the use of a cradle.

In an alternative scenario, the user holds the mobile phone 1 in one hand and interacts with the virtual input means with the other hand (not shown), i.e. the other hand is used to tap on a work surface. With the hand holding the mobile phone 1 the user aims the camera 23 at the other hand that is interacting with the virtual input means. This use is particularly attractive for users that need to get some input realized quickly and do not wish to take the time to set up the mobile phone on a desk or the like.

FIGS. 4A and 4B show another embodiment of the invention in the form of a so-called clamshell type mobile phone 1. The mobile phone 1 according to this embodiment is essentially the identical with mobile phone described in the embodiment above, except for the construction of the housing of the mobile phone. In the embodiment of FIGS. 4A and 4B the housing 2 includes a first housing part 2a that is hinged to a second housing part 2b and allows the first and second housing parts to be folded together and opened again. In the opened position shown in the figures the second housing part 2b serves as a foot that rests on the work surface 30 thereby allowing the first housing part 2a to be disposed in an upright position without any further assistance. Therefore, the virtual input means of the mobile phone 1 according to this embodiment can be operated with two hands without the use of a cradle or other external device to keep the housing 2 of the mobile phone positioned correctly relative to the work surface and the users hands. This embodiment includes a digital camera on the rear 23 of housing part 2a and a digital camera 23a on the front of the housing part 2a. Either of the digital cameras 23,23a can be used for detecting the movement of the users finger(tip)s. When front digital camera 23a is used the users hands are placed on a work surface in front of the mobile electronic device 1 and when the rear digital camera 23 is used the users hands are placed on a work surface behind the mobile electronic device 1.

The virtual input means may assume various forms, such as a keyboard, a touchpad, a collection of menu items, a collection of icons or combinations of these items. The mask associated with the virtual input means can be flexibly changed and many different types of masks and virtual input means can be stored/programmed into the mobile phone and used in accordance with circumstances or upon command from the user. Thus, the mask can be application specific.

When the virtual input device is used for inputting text, the text entry robustness is according to one variation of the embodiment improved by using language specific predictive editing techniques. Further, according to another variation of the embodiment, a word completion algorithm is used in which the software provides the user with suggestions for completing the word to thereby reduce the typing effort.

FIG. 5 illustrates in block diagram form the general architecture of a mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 19 (for the LEDS backlighting the keypad 7 and the display 3), the SIM card 20, battery 24, the bottom connector 27, the DC jack 31 (for connecting to the charger 33), the audio amplifier 33 that drives the (hands-free) loudspeaker 25 and the optional accelerometer 57.

The processor 18 also forms the interface for some of the peripheral units of the device, including a Flash ROM memory 16, the graphical display 3, the keypad 7, the navigation key 40, the digital camera 23 and an FM radio 26.

The fingertip, represented with an average moving factor in the optical flow field is detected and tracked with an optical flow algorithm that is performed by the processor 18.

The signal from the microphone 6 and/or the accelerometer 57 is processed in the DSP 17 in a triggering algorithm in which the signal from the acoustic sensor is processed to perform a logical switch operation.

A separate training sequence to train and calibrate the sound or vibration detector can be used to optimize the configuration before usage. According to an alternative embodiment (not shown) multiple microphones are used to enable the utilization of beam-forming techniques to improve the detection in noisy environments. According to yet another embodiment (not shown) dedicated materials are used to improve the detection accuracy, such as a rollable polymeric pad acoustically well determined. The user may train and calibrate the system (before use) by exploiting the sound created by his/her fingernails impacting with the work surface. The sound of fingernails hitting a surface is very well determined and therefore particularly suitable for use with the virtual input device.

The orientation of the microphone 6 is according to a variation of the invention such that the microphone diaphragm is parallel to the work surface 30, thereby exploiting the maximum vibration sensitivity of the microphone diaphragm that is orthogonal to its surface. This orientation is normally achieved in the mobile phone according to the embodiment of FIGS. 4A and 4B, when the microphone is conventionally placed in the housing part 2b.

According to a variation of the present embodiment the robustness of the switch detection is improved by using multiple sensors and by applying sensor fusion techniques to produce the detection signal. Keystroke can be detected by a simultaneous visual motion in the video, acoustic sound, sound direction (with multiple microphones) and mechanical vibration. These signals are appropriately combined to improve keystroke. Microphone array is used for the detection of acoustic sound direction. This is utilized for separating the left hand keystrokes and the right hand keystrokes from the sound direction information. This is particularly useful in very fast typing where several fingers (three or more) are visible to the camera 23 simultaneously.

At the impact moment, while a sound is propagated into the microphone 6 or a vibration into the accelerometer 57, the processor 18 will detect and select the fingertip with the biggest average moving vector as the key pressing finger. The input function or command associated with the position of the fingertip with the biggest average moving vector is executed by the processor 18 when the trigger algorithm indicates that an impact on the finger with the work surface 30 has taken place.

In addition to microphone or accelerometer driven switch an alternative software based switch driven by the signal from the camera 23 is used. In the software switch the detection of a downward movement followed by an upward movement (a bounce on a solid support) is used as an indication that a keystroke has taken place at the moment of the change of direction. Thus, there is a sudden (abrupt) change in finger velocity and/or direction of the finger movement. In the software switch the abrupt change in velocity and/or direction is used to determine which finger is used for an input and thereby provide an alternative for detecting a keystroke.

The fingertip detection image processing flow includes a segmentation/recognition of the fingers and attribution of the center of gravity to a fingertip position and point their projection on the display 3. Further, the fingertip detection image processing flow includes fingertip tracking/real-time movement of the pointers attributed to the fingertips. The finger segmentation portion extracts the finger from the background and attributes the center of gravity to the front finger part (fingertip). Hereto, the skin color is used. Due to the invariance of a person's finger color the extraction can be based on the color difference between the user's fingers and the static background image. The differentiation procedure can be improved by a learning process to calibrate the color variance of a particular user. The learning procedure includes requiring the user to place his/her finger in a learning square on the screen, whereafter the calibration is performed.

The fingertip tracking algorithm can be based on correlations between two or more subsequent image frames from which the finger movement is calculated to obtain a vector representing the velocity of the fingertip.

Although the invention has only been illustrated above as implemented on a mobile phone, the invention can be used by other electronic devices, such as multimedia devices, mobile offices, and miniaturized PCs.

The term “comprising” as used in the claims does not exclude other elements or steps. The term “a” or “an” as used in the claims does not exclude a plurality. The single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention.

1. A mobile electronic device with a virtual input device, said mobile electronic device comprising:
an optical sensor, for detecting movement of a user's fingers over a work surface, and for generating a signal responsive to the detected movement;
an acoustic or vibration sensor, for detecting an impact of the user's fingers on the work surface and for generating a signal responsive to the detected impact;
a first processor, coupled to the optical sensor and a second processor coupled to the acoustic sensor, for receiving and processing the detected signals as input for the electronic device.

2. A device according to claim 1, wherein said first processor is configured to determine the position where a finger impacts with the work surface from the signal generated by the optical sensor and to determine that an impact of a finger and the work surface has taken place from the signal generated by the acoustic or vibration sensor.

3. A device according to claim 1, wherein a particular input command is associated with each of a plurality of fingertip positions, and wherein said first processor is configured to accept the function associated with a given fingertip position when a fingertip movement towards the position concerned is detected to substantially coincide with the detection of a fingertip impact.

4. A device according to any of claims 1, wherein said first processor is configured to track the movement of the user's fingers.

5. A device according to claim 4, further comprising a display, wherein said first processor is configured to provide real-time fingertip positions projected at the display.

6. A device according to claim 5, wherein said first or second processor is configured to show a virtual navigation mask on the display for providing optical feedback and/or guidance to the user.

7. A device according to claim 6, wherein said virtual navigation mask includes virtual input elements comprising virtual keypads or keyboards, icons and/or menu items.

8. A device according to claim 7, wherein said first or second processor is configured to highlight the virtual input element associated with the fingertip position when a fingertip movement towards said fingertip position and a fingertip impact have been detected.

9. A device according to claim 1, comprising a housing, wherein said housing comprises a front side in which the display is disposed and a rear side in which the optical sensor is disposed, said device further comprising a support member for keeping the housing in a substantially upright position.

10. A device according to claim 1, wherein said optical sensor is a general-purpose digital photo or video camera.

11. A device according to claim 1, wherein said acoustic sensor is a general-purpose microphone.

12. A device according to claim 1, wherein said device comprises a housing with hinged first and second housing parts, the first hinged housing part being configured to serve as a leg or foot for resting on the work surface to allow the second housing part to assume a substantially upright position.

13. A device according to claim 12, wherein the microphone or accelerometer is disposed in said first housing part and the display and the camera are disposed in the second housing part.

14. A device according to claim 1, wherein said second processor is configured to detect an impact of a finger with the work surface by performing a triggering algorithm in which the signal from the acoustic sensor is processed to perform a logical switch operation.

15. A device according to claim 14, wherein the triggering algorithm is based on:
the sounds or vibrations that travel through the solids in the environment of the acoustic or vibration sensor,
the sounds that travel through the air in the environment of the acoustic sensor,
or a combination of the sounds or vibrations that travel to the solids in the environment of the acoustic or vibration sensor and the sounds that travel through the air in the environment of the acoustic sensor.

16. A device according to claim 1, wherein said first processor and said second processor are integrated in one processor unit.

17. A method for generating input in a mobile electronic device comprising:
optically detecting movement of a user's fingers over a work surface,
acoustically or vibrationally detecting impact of a user' fingers on the work surface, and
processing said signals as input.

18. A method according to claim 17, further comprising determining the position where a finger impacts with the work surface from the signal generated by the optical sensor and determining that an impact of a finger and the work surface has taken place from the signal generated by the acoustic or vibration sensor.

19. A method according to claim 17, further comprising associating a particular input command with each of a plurality of fingertip positions, and accepting the input command associated with a given fingertip position when a fingertip movement towards the position concerned is detected substantially simultaneously with the detection of a fingertip impact.

20. A method according to claim 17, further comprising processing the signals from the optical sensor and from the acoustic or vibration sensor to determine whether a fingertip of said user contacted a location defined on said virtual input device, and if contacted to determine what function of said virtual input device is associated with said location.

21. A method according to claim 17, further comprising tracking the movement of the user's fingers and/or finger speed.

22. A method according to claim 21, wherein said device comprises a display, comprising providing real-time fingertip positions projected at the display.

23. A method according to claim 17, further comprising detecting an impact of a finger with the work surface by performing a triggering algorithm in which the signal from the acoustic sensor is processed to perform a logical switch operation.

24. A method according to claim 23, further comprising showing a virtual navigation mask on the display for providing optical feedback to the user.

25. A method according to claim 24, wherein said virtual navigation mask includes virtual input elements comprising virtual keypads or keyboards, icons and/or menu items.

26. A method according to claim 25, further comprising highlighting the virtual input element associated with the fingertip position when a fingertip movement towards said fingertip position and a fingertip impact have been detected.

27. A method according to claim 24, wherein the virtual mask only shows the characters or symbols associated with the key of a virtual keypad.

28. A method according to claim 27 wherein the virtual mask further shows key contours of the keys of a virtual keypad or shows partition lines between the characters or symbols associated with the key of a virtual keypad.

29. A mobile electronic device with a virtual input device, said mobile electronic device comprising:
an optical sensor, for detecting movement of a user's fingers over a work surface, and for generating a signal responsive to the detected movement;
a processor coupled to said optical sensor for receiving and processing the detected signal as input for the electronic device, and
a display coupled to the optical sensor, wherein
the processor is configured to show a real-time representation of the position user's fingers or fingertips as captured by the optical sensor on the display.

30. A device according to claim 29, wherein said processor is configured to provide real-time fingertip positions projected at the display.

31. A device according to claim 29, wherein the representation of the user's fingers on the display is in the form of pointers or hand- or finger shadows.

32. A device according to claim 30, wherein the representation of the user's fingers on the display is in the form real time images.

33. A device according to claim 29, wherein the representation of the user's fingers on the display is projected into another application.

34. A device according to claim 29, wherein said processor is configured to display a virtual navigation mask over the representation of the users fingers for providing optical feedback to the user.

35. A device according to claim 34, wherein said virtual navigation mask includes virtual input elements.

36. A device according to claim 35, wherein said virtual input elements are virtual keypads or keyboards, icons and/or menu items.

37. A device according to claim 29, wherein the processor is configured to determine the position where a finger impacts with the work surface from the signal generated by the optical sensor.

38. A device according to claim 37, wherein a particular input command is associated with each of a plurality of fingertip positions, and wherein said processor is configured to accept the function associated with a given fingertip position when a fingertip movement towards the position concerned is detected.

39. A device according to claim 38, wherein said processor is configured to track the movement of the user's fingers or fingertips.

40. A device according to claim 29, wherein said optical sensor is a general-purpose digital photo or video camera.

41. A method for generating input in a mobile electronic device with an optical sensor and a display comprising:
optically detecting movement of a user's fingers over a work surface,
showing a real-time representation of the position of a user's fingers or fingertips as captured by the optical sensor on the display, and
processing said signals as input.

42. A method according to claim 41, further comprising tracking the movement of the user's fingers and/or fingers speed.

43. A method according to claim 41, further comprising determining the position where a finger impacts with the work surface from the signal generated by the optical sensor.

44. A method according to claim 41, further comprising associating a particular input command with each of a plurality of fingertip positions.

45. A method according to claim 41, further comprising processing the signals from the optical sensor to determine whether a fingertip of said user contacted a location defined on said virtual input device, and if contacted to determine what function of said virtual input device is associated with said location.

46. A method according to claim 41, further showing a virtual navigation mask on the display for providing optical feedback to the user.

47. A method according to claim 46, wherein said virtual navigation mask includes virtual input elements comprising virtual keypads or keyboards, icons and/or menu items.

48. A method according to claim 47, further comprising highlighting the virtual input element associated with the fingertip position when a fingertip movement towards said fingertip position and a fingertip impact have been detected.

49. A method according to claim 46, wherein the virtual mask only shows the characters or symbols associated with the key of a virtual keypad.

50. A method according to claim 49, wherein the virtual mask further shows key contours of the keys of a virtual keypad or shows partition lines between the characters or symbols associated with the key of a virtual keypad.
